(19) United States
(12) Patent Application Publication
(10) Pub. No.: US 2021/0129761 A1
(43) Pub. Date: May 6, 2021

(54) Vehicle Seat Side Accessory

(71) Applicant: Covercraft Industries, LLC, Pauls Valley, OK (US)

(72) Inventors: Mike Lann, Pauls Valley, OK (US); John Leegard, Pauls Valley, OK (US); Mark Korros, Pauls Valley, OK (US)

(21) Appl. No.: 16/668,855

(22) Filed: Oct. 30, 2019

(51) Int. Cl. B60R 7/00; B60R 22/26

(52) U.S. Cl. CPC B60R 7/00; B60R 2022/1806; B60R 22/26

(57) ABSTRACT

A vehicle seat side accessory includes a filler portion on one end and a pocket portion on an opposite end. The accessory is reversible, and can be used in the filler configuration with the filler portion or cushion disposed in the crevice between a seat and a center console, and also in the pocket configuration with the pocket portion disposed in the crevice. The accessory includes an opening that may accept a seat belt. The accessory may include a seat belt opening on both the filler portion and pocket portion.

### FIELD OF THE TECHNOLOGY

This disclosure is directed toward vehicle interior accessories. Specifically, this invention is directed toward a seat side accessory for the interior of a vehicle that acts either as a filler or a pocket.

### BACKGROUND OF THE TECHNOLOGY AND RELATED ART

The interior of a vehicle presents various opportunities for useful accessories for managing and organizing cargo. The space between a vehicle seat and another portion of the vehicle interior such as a center console presents unique challenges and opportunities for vehicle accessories. Often, the space between the seat and the console is useless or wasted space, or becomes a void into which items may fall and become lost.

Traditionally, various devices have been employed to fill the space between a seat and a console. However, there continues to be a need for an improved vehicle seat side accessory.

### BRIEF DESCRIPTION OF THE DRAWINGS

The present technology will become more fully apparent from the following description and appended claims, taken in conjunction with the accompanying drawings. Understanding that these drawings merely depict exemplary aspects of the present technology they are, therefore, not to be considered limiting of its scope. It will be readily appreciated that the components of the present technology, as generally described and illustrated in the figures herein, could be arranged and designed in a wide variety of different configurations. Nonetheless, the technology will be described and explained with additional specificity and detail through the use of the accompanying drawings in which:

FIG. 1 is a perspective right, bottom view of the vehicle seat side accessory in accordance with one aspect of the technology;

FIG. 2 is a perspective left, top view of the accessory of FIG. 1;

FIG. 3 is a right side view of the accessory of FIG. 1;

FIG. 4 is a left side view of the accessory of FIG. 1;

FIG. 5 is a top view of the accessory of FIG. 1;

FIG. 6 is a bottom view of the accessory of FIG. 1;

FIG. 7 is a back view of the accessory of FIG. 1; and,

FIG. 8 is a front side view of the accessory of FIG. 1.

### DETAILED DESCRIPTION

The following detailed description includes reference to the accompanying drawings, which form a part hereof and in which are shown, by way of illustration, exemplary embodiments. It is believed that the seat side accessory of the present disclosure, including a reversible configuration having either a filler cushion or a pocket, will provide improved versatility and performance for seat side accessories. However, before the present technology is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a line” includes a plurality of such lines.

In this disclosure, “comprises,” “comprising,” “containing,” “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term, like “comprising” or “including,” in this specification it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

Objects described herein as being “adjacent to” each other may be in physical contact with each other, in close proximity to each other, or in the same general region or area as each other, as appropriate for the context in which the phrase is used.

Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially enclosed” would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

Example Embodiments

It should be understood that the aspects of the technology discussed herein are contemplated for use with any type of vehicle accessory. For purposes of illustrating the various aspects of the methods and systems claimed herein, the discussion below will be primarily directed to describing exemplary embodiments directed to a seat side accessory for the interior of a vehicle. It should be noted, however, that the elements and principles discussed herein are applicable to other applications. It is also noted that discussion of methods and systems herein can be interchangeable with respect to specific aspects. In other words, specific discussion of one method or system (or components thereof) herein is equally applicable to other aspects as they relate to the system or method, and vice versa.

Aspects of the technology provide for a vehicle seat side accessory that is reversible and can be installed between a vehicle seat and another portion of the vehicle, such as a center console. Though the accessory will be discussed in one example as an accessory for the interior of a vehicle between a seat and a center console, in other aspects the same or similar features, in any configuration, can be applied to use between any two vehicle components, either in the interior or the exterior, including but not limited to between an interior seat and a door, between two interior seats, or between an exterior seat, bench, or workspace and any other portion of the exterior.

The accessory according to aspects of the present technology includes both a filler cushion portion and a pocket portion. It may be desirable to have a single accessory that can either act as a filler cushion to prevent items from falling between a vehicle seat and another portion of a vehicle interior such as a center console, and also to act as a pocket that can receive and store various items in the otherwise unusable space between a seat and another portion of the vehicle. For example, the vehicle seat side accessory of the technology may include a filler cushion on one end and a pocket on the opposite end, such that one is disposed below the other within the gap between a vehicle seat and another portion of the interior. Alternatively, the seat side accessory may include two filler cushions of different lengths, widths, heights, or fill density, or it may include two pockets of different sizes. According to aspects of the technology, the vehicle seat side accessory includes an opening in either or both of the filler or the pocket portion of the accessory. The opening is configured and dimensioned to receive a portion of a seat belt. The vehicle accessory of the present technology provides various advantages including increased versatility and better performance as both a filler and a pocket.

The vehicle seat side accessory according to aspects of the technology includes a filler cushion portion and a pocket portion. The pocket portion includes a pocket having first and second sidewalls or sides forming a cavity. A connecting member having a first and second end connects the filler cushion portion to the pocket portion. In other words, the filler cushion portion is connected to the first end and the pocket portion is connected to the second end. The accessory also includes an opening disposed in at least one of the filler cushion portion and the pocket portion. The opening is configured and dimensioned to receive a seat belt, such as the female latch portion of a seat belt that sticks out from beside a seat, or in other words, between a seat and the center console of a vehicle.

In some aspects of the technology, the opening is disposed within the cavity of the pocket portion of the accessory, or in other words is formed from cutouts in the first and second sidewalls or sides. In some aspects, the opening is a first opening disposed in the filler cushion portion and a second opening disposed in the pocket portion. Accordingly, the accessory includes a seat belt opening when disposed either with the cushion upright or with the pocket upright in the space between a seat and a center console.

The vehicle accessory according to aspects of the present disclosure can be made of material chosen from one or more of polyester, polycotton, leather, microfiber, velour, or neoprene. For example, the filler cushion may include a top section and a bottom section of such material, the top and bottom sections sewn together at their perimeter. The cushion may also include a filler material between the top and bottom sections. The filler material can be chosen from one or more of foam, fiberfill, polyfill, cotton-polyfill, or cotton. In certain aspects, the filler cushion is configured and dimensioned to cover the space between a seat and a center console. In this way, the accessory provides the advantages of blocking objects from falling into the crevice or space between a seat and a center console. In may also act as support for objects which a user wishes to place beside them in a vehicle.

In other aspects, the pocket portion is configured and dimensioned to cover the space between a seat and a center console. The pocket portion may provide advantages similar to those of the filler cushion, while also providing a convenient cavity or pocket in which items may be stored and easily accessible. The accessory of the present disclosure also provides the advantage of being reversible, or in other words, including both a cushion filler portion and a pocket portion in a single accessory. In certain aspects, the filler cushion portion and the pocket portion are configured to collapse and fit within the space between a seat and a center console when the other of the filler cushion portion or the pocket portion are positioned to cover the space between the seat and the center console.

One aspect of the present technology includes a vehicle interior organization system. The system includes a cushion having a top portion and a bottom portion. The top and bottom portions of the cushion are sewn together at their perimeter and include a filler material disposed between the top and bottom portions. The system also includes a pocket having first and second sidewalls or sides. The sidewalls are sewn together at both ends and at the bottom, but open at the top to form a cavity or pocket. The accessory also includes a connecting member having first and second ends, with the cushion attached to the first end and the pocket attached to the second end of the connecting member, creating the reversible accessory as discussed herein.

In an aspect of the system, an opening is disposed in at least one of the cushion and the pocket. The opening is configured and dimensioned to receive a portion of a seat belt. In one aspect, the opening can receive the female latch portion of a seat belt. In other words, the female latch portion of the seat belt, which generally resides between a seat and a center console, may protrude through the vehicle interior organization system and extend above either the cushion or the pocket, allowing easy access to buckle a seatbelt. In other aspects, the opening may be configured to receive any portion of the seat belt, such as the male buckle end, or a length of the belt itself. The opening of the system may include one or more of a first opening disposed in the top and bottom portions of the cushion, and a second opening disposed within the cavity in the first and second sidewalls of the pocket. In one aspect, the opening may include two side seams disposed opposite one another on both the top and bottom portions of the cushion, and an interior seam disposed opposite a front sewn side of the top and bottom portions of the cushion, to form the opening in the cushion. In other aspects, the opening may include a seam extending from a front side of the pocket, where the first and second sidewalls meet, into the cavity and back to the front side. The seam may prevent the first and second sidewalls of the pocket from being sewn together at the bottom, thereby creating the opening in the pocket.

In aspects of the system according to the present technology, the cushion, pocket and connecting member are made of material chosen from one or more of polyester, polycotton, leather, microfiber, velour, or neoprene. The cushion includes in certain aspects a filler material that can be chosen from one or more of foam, fiberfill, polyfill, cotton-polyfill, or cotton. The system may be assembled from panels of material cut from a pattern, then sewn and folded together to form the parts of the system, as described herein. For example, in one aspect of the invention, the cushion may be formed from a single piece of material cut to the appropriate shape of the top and bottom of the cushion. The cushion may be folded, stuffed, and stitched to form the filler cushion portion. Similarly, the pocket portion and the connecting member together may be formed of a single piece of material. The material may be cut into the appropriate sidewalls of the pocket and include the connecting member, then may be folded and sewn to form the connecting member with a pocket member on one side. The filler cushion portion may then be sewn to the other side of the connecting member to form the accessory as disclosed herein and in accordance with the system discussed above.

In other aspects of the invention, the pocket may also include filler material to give the pocket the required thickness to fill the desired space. For example, each sidewall of the pocket may include an inner and outer sidewall, with filler material disposed between the sidewall. In such an example, the pocket may be configured to have a right side of the pocket with a first sidewall, having an outer sidewall configured to abut or be adjacent to a center console and an inner sidewall configured to form the right side of the pocket or cavity. Similarly, the left side of the pocket may have a second sidewall, having an inner sidewall configured to form the left side of the pocket or cavity, and an outer sidewall configured to abut or be adjacent to the seat. Depending on the width between the seat and the center console, for example, the size of the sidewalls and relative amount of filler material required may be adjusted to produce a customized fit for any vehicle.

In aspects of the invention, the accessory may be vehicle specific and be sized and shaped to fit specific years, makes and models of vehicles, similar to vehicle seat covers. In other aspects of the invention, the accessory and system may be universal, and provided with general dimensions that are likely to work in the majority of applications. In yet other aspects, the size and shape may be adjustable, such as through folds, snaps and other attachments that may allow the length, depth or width to be decreased or increased.

A method for filling a gap between a vehicle seat and a center console is also included in aspects of the present disclosure of technology, which will be appreciated in light of the systems and devices discussed herein. In one aspect, the method includes providing a filler cushion portion of a vehicle accessory. The filler cushion portion can include a filler cushion configured and dimensioned to fit between the vehicle seat and the center console. The method also includes providing a pocket portion of the vehicle accessory. The pocket portion can include a first and second wall forming a cavity, the cavity configured and dimensioned to fit between the vehicle seat and the center console. The method also includes attaching the pocket portion to the filler cushion portion such that each is disposed on an opposite end of the vehicle accessory.

According to aspects of the method, an opening is disposed on one or both of the filler cushion portion and the pocket portion. In one aspect, the opening is disposed in the pocket portion, and specifically is disposed within the cavity on the pocket portion, as discussed in greater detail herein. In another aspect, the both the filler cushion portion and the pocket portion include an opening, such that each is capable of receiving portions of a seat belt, either at the same time, or individually, depending on the configuration within the crevice between a seat and a center console.

Aspects of the method also include both the filler cushion portion and the pocket portion being configured to collapse and fit within the space or crevice between the seat and the center console when the other of the filler cushion portion or the pocket portion are positioned to cover the space between the seat and the center console.

The accessory of the present invention will provide various advantages over existing accessories. For example, a user may have to decide between having a filler cushion or a pocket between a seat and a center console, or purchase two separate devices to have the option of either a cushion or a pocket. According to aspects of the present technology, a single device provides both the cushion and the pocket, and is easily and conveniently reversible to allow a user to choose. Various other advantages will be apparent throughout the discussion herein.

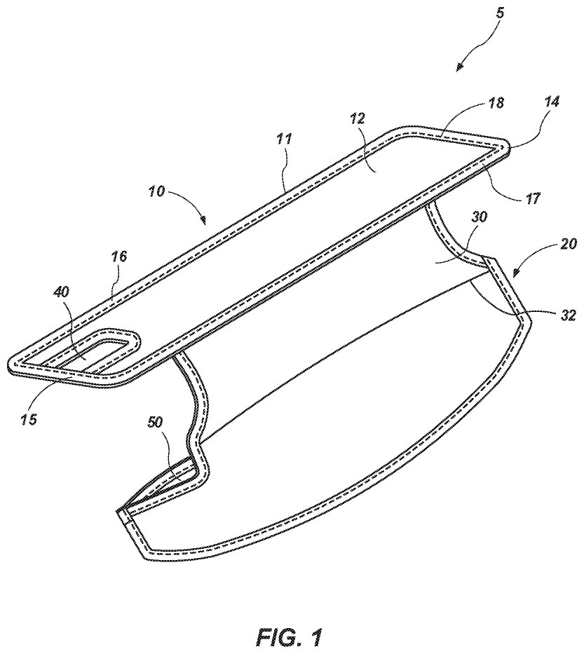

Now, with specific reference to FIG. 1, a vehicle accessory 5 according to aspects of the present technology is shown. The accessory 5 includes a filler cushion portion 10 and a pocket portion 20 with a connecting member 30. The filler cushion portion 10 includes a filler cushion 11 having a top side 12 and a bottom side 13. The top and bottom sides 12, 13 of the cushion 11 are sewn together at a perimeter 14 of the filler cushion 11. The filler cushion 11 includes a front side 15, a first or left side 16, a second or right side 17, and a back side 18. The sides 15, 16, 17, 18 of the filler cushion form the perimeter 18, and include the seam that holds the top side 12 and the bottom side 13 together. As discussed herein, a filler material may be disposed between the top side 12 and the bottom side 13 of the filler cushion.

The accessory 15 includes a first opening 40 and a second opening 50. The first opening 40 is disposed in the filler cushion portion 10 and the second opening 50 is disposed in the pocket portion 20. The first and second openings 40, 50 are configured and dimensioned to receive a portion of a seat belt, such as the female latch portion of a seat belt, when the accessory 5 is installed in a vehicle, for example in the space or crevice between a seat and a center console.

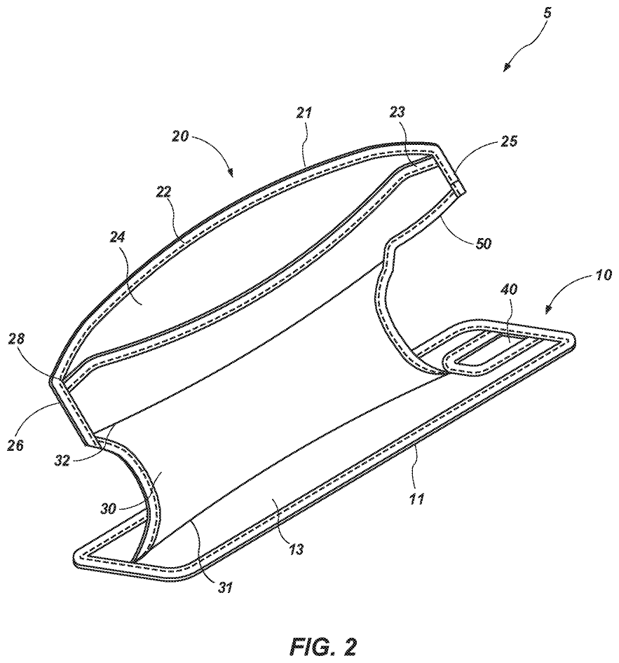

As shown in FIG. 2, vehicle accessory 5 includes connecting member 30 having a first end 31 and a second end 32. Cushion 11 of filler cushion portion 10 is attached to the first end 31 of the connecting member 30. Specifically, bottom side 13 of filler cushion 11 is attached at the first end 31 of the connecting member 30. Similarly, pocket portion 20 is attached at a second end 32 of connecting member 30.

Pocket portion 20 includes a pocket 21 having a first or right side or sidewall 22 and a second or left side or sidewall 23. First and second sidewalls 22, 23 form a cavity 24, which is configured and dimensioned to receive and store items. The cavity 24 may be formed by sewing the front 25, back 26 and bottom 27 of pocket 21, leaving the top 28 open. A portion of the bottom 27 of the pocket 21 may not be sewn together, and may form opening 50. Opening 50 is formed within the cavity 24 of the pocket 21. In other aspects, opening 50 may be formed outside of the pocket 21, or be attached to an outside surface of the pocket portion 20. In aspects of the invention where opening 50 is formed within cavity 24 of pocket 21, the opening 50 within the pocket 21 provides advantages, including space saving and continuity in the integration and looks of the accessory 5 when installed between a seat and a center console of a vehicle.

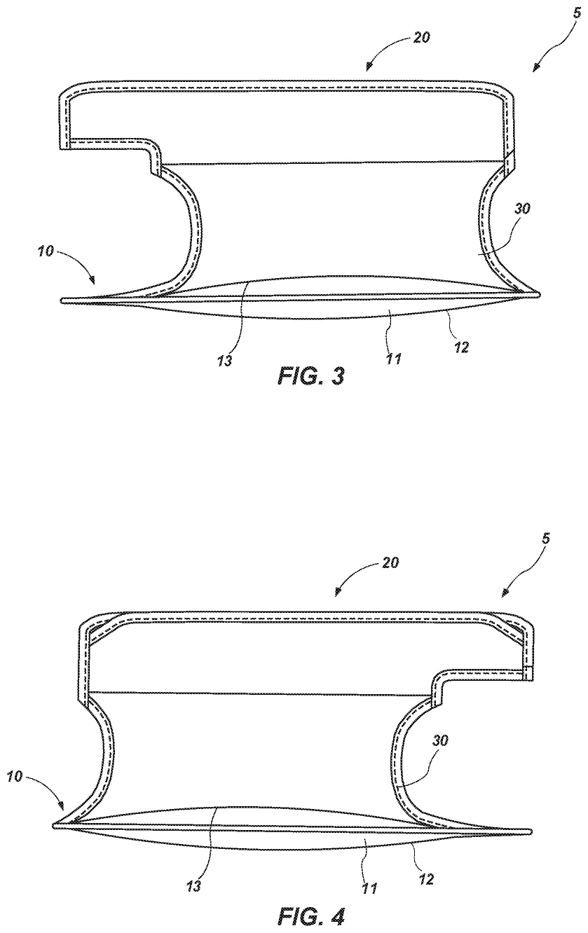

Now, with reference to FIGS. 3-8, various detailed aspects of the vehicle accessory 5 are shown. The cushion filler portion 10 and the pocket portion 20 are attached by the connecting member 30 in such a way that connecting member 30 does not interfere with openings 40, 50. For example, connecting member 30 may have curved sides, reducing the amount of material needed and providing clearance for openings 40, 50. In other aspects, connecting member 30 may simply be one or more strands of material, such as a strap, a ribbon, a string, or any other dimensioned material in any form suitable for connecting cushion filler portion 10 and pocket portion 20 as discussed herein.

Cushion or filler 11 of filler cushion portion 10 includes a top surface 12 and a bottom surface 13 attached together at a perimeter 14 by sewing or other attachment methods, such as gluing, stapling or any other means. A filler may be disposed between top and bottom surfaces 12, 13 as discussed herein to provide the desired dimensions and capability for filling the space of the specific application, such as the space or crevice between a vehicle seat and a center console.

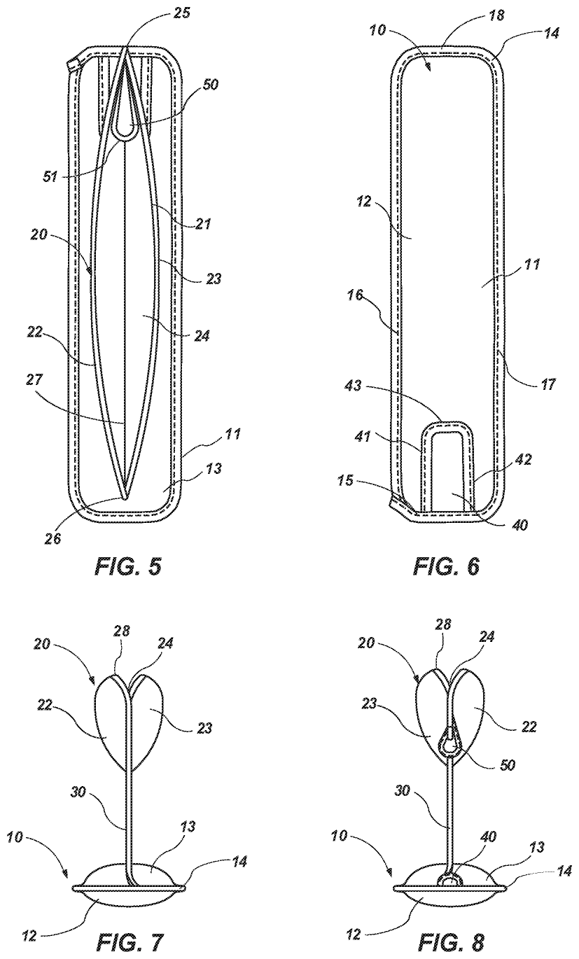

With specific reference to FIG. 5, opening 50, or second opening, in pocket portion 20 may be disposed within pocket 21 or within the cavity 24 of pocket 21 formed by sidewalls 22, 23. In one aspect, opening 50 includes seam 51, which travels from front side 25 of pocket 21 toward cavity 24, then back to front side 25, thereby forming opening 50. Seam 51 may be collinear with the bottom 27 of pocket 21, or in other words may be a seam formed at the bottom surface of sidewalls 22, 23. In one aspect, sidewalls 22, 23 are attached at the front 25, back 26 and bottom 27 of pocket 21, such as by sewing or other attachment means. However, for a portion of bottom 27 of pocket 21, sidewalls 22, 23 may not be attached, and seam 51 may thereby form opening 50.

In aspects of the technology, sidewalls 22, 23 are singular pieces of material. In other aspects, first sidewall 22 and second sidewall 23 each include an inside member and an outside member, giving the sidewalls 22, 23 the ability to hold a filler material. Filler material may be added to sidewalls 22, 23 to give each a specific dimension suitable for filling a space or crevice in a certain application. For example, as specifically shown in FIGS. 7-8, sidewall 22 and sidewall 23 have a rounded, protruding shape owing to the filler. In other aspects of the invention, the pocket 21, and specifically the sidewalls 22, 23 of the pocket, may take other forms to fit within the specified application. In some aspects, accessory 5 may be specifically dimensioned for the specific year, make and model of vehicle for which it is designed, including the specific shape and size of the pocket 21. In other aspects, accessory 5 may be universal, dimensioned as likely to fit various applications.

With reference now to FIG. 6, opening 40, or first opening, in cushion portion 10 may be an opening formed in both the top 12 and bottom 13 of cushion 11. Specifically, opening 40 may include a left side seam 41, or first opposing side seam, a right side seam 42, or second opposing side seam, and an interior seam 43. Interior seam 43 may be opposite the front side 15 of the perimeter 14 of cushion 11. Side seams 41, 42 and interior seam 43, together with the perimeter 14 of the cushion 11, may form opening 40. Opening 40 may be sized for specific applications, and configured and dimensioned to accept a portion of a seat belt, such as the female buckle portion. In aspects of the technology, the portion of the seat belt will sit above the top surface 12 of the cushion 11 when installed to provide the user normal access to the seat belt, while fulfilling the purpose of filling the crevice or space between a seat and a center console.

In general, the technology provides for a reversible seat side accessory for vehicles providing either a filler cushion or a pocket. The reversibility of the seat side accessory provides various advantages, as discussed herein. Moreover, the seat belt openings provide advantages, including the ability to have a seat belt opening in both of the reversible portions of the accessory, and the ability to have the seat belt travel through the pocket by having the opening within the cavity of the pocket. Various other advantages will be known to those of skill in the art based on the disclosure herein.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, examples which are to be construed as non-exclusive. For example, in the technology, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A vehicle seat side accessory, comprising:
a filler cushion portion;
a pocket portion;
a connecting member having a first and second end, the filler cushion portion connected to the first end and the pocket portion connected to the second end; and,
an opening disposed in at least one of the filler cushion portion and the pocket portion, the opening configured and dimensioned to receive a seat belt.

2. The accessory of claim 1, wherein the pocket portion comprises a pocket having first and second sides forming a cavity, and wherein the opening is disposed within the cavity.

3. The accessory of claim 1, wherein the opening comprises a first opening disposed in the filler cushion portion and a second opening disposed in the pocket portion.

4. The accessory of claim 3, wherein the pocket portion comprises a pocket having first and second sides forming a cavity, and wherein the second opening is disposed within the cavity.

5. The accessory of claim 1, wherein the opening is configured and dimensioned to receive the female latch portion of a seat belt.

6. The accessory of claim 1, wherein the accessory is made of one or more of polyester, polycotton, leather, microfiber, velour, or neoprene.

7. The accessory of claim 1, wherein the filler cushion comprises top section and a bottom section, the top and bottom sections sewn together at their perimeter, and filler material between the top and bottom sections.

8. The accessory of claim 7, wherein the filler material is one or more of foam, fiberfill, polyfill, cotton-polyfill, or cotton.

9. The accessory of claim 1, wherein filler cushion is configured and dimensioned to cover the space between a seat and a center console.

10. The accessory of claim 1, wherein the both the filler cushion portion and the pocket portion are configured to collapse and fit within the space between a seat and a center console when the other of the filler cushion portion or the pocket portion are positioned to cover the space between the seat and the center console.

11. A vehicle interior organization system, comprising:
a cushion comprising a top portion and a bottom portion, the top and bottom portions sewn together at their perimeter with a filler material disposed between the top and bottom portions;
a pocket comprising first and second sidewalls, the sidewalls sewn together at both ends and at the bottom, but open at the top to form a cavity;
a connecting member having first and second ends, the cushion attached to the first end and the pocket attached to the second end; and
an opening disposed in at least one of the cushion and the pocket, the opening configured and dimensioned to receive a portion of a seat belt.

12. The system of claim 11, wherein the opening comprises a first opening disposed in the top and bottom portions of the cushion, and a second opening disposed within the cavity in the first and second sidewalls of the pocket.

13. The system of claim 11, wherein the opening comprises two side seams disposed opposite one another on both the top and bottom portions of the cushion, and an interior seam disposed opposite a front sewn side of the top and bottom portions of the cushion.

14. The system of claim 11, wherein the opening comprises a seam extending from a front side where the first and second sidewalls meet into the cavity and back to the front side, the seam preventing the first and second sidewalls from being sewn together at the bottom.

15. The system of claim 11, wherein the opening is configured and dimensioned to receive a female latch portion of a seat belt.

16. The system of claim 11, wherein the cushion, pocket and connecting member are made of material chosen from one or more of polyester, polycotton, leather, microfiber, velour, or neoprene.

17. A method for filling a gap between an vehicle seat and a center console, the method comprising:
providing a filler cushion portion of a vehicle accessory, the filler cushion portion comprising a filler cushion configured and dimensioned to fit between the vehicle seat and the center console;
providing a pocket portion of the vehicle accessory, the pocket portion comprising a first and second wall forming a cavity, the cavity configured and dimensioned to fit between the vehicle seat and the center console; and
attaching the pocket portion to the filler cushion portion such that each is disposed on an opposite end of the vehicle accessory.

18. The method of claim 17, wherein an opening is disposed on both the filler cushion portion and the pocket portion.

19. The method of claim 18, wherein the opening is disposed within the cavity on the pocket portion.

20. The method of claim 17, wherein both the filler cushion portion and the pocket portion are configured to collapse and fit within the space between the seat and the center console when the other of the filler cushion portion or the pocket portion are positioned to cover the space between the seat and the center console.
